(19) United States
(12) Patent Application Publication
(10) Pub. No.: US 2025/0220670 A1
(43) Pub. Date: Jul. 3, 2025

(54) A CONFIGURATION BASED ON CONFIGURED GRANT UPLINK CONTROL INFORMATION

(71) Applicant: Lenovo (Singapore) Pte. Ltd., Singapore (SG)

(72) Inventors: Hossein Bagheri, Dearborn Heights, MI (US); Razvan-Andrei Stoica, Witten (DE); Joachim Löhr, Wiesbaden (DE); Alexander Golitschek Edler von Elbwart, Darmstadt (DE); Hyejung Jung, Northbrook, IL (US); Vijay Nangia, Woodridge, IL (US)

(21) Appl. No.: 18/852,000

(22) PCT Filed: Mar. 28, 2023
(86) PCT No.: PCT/IB2023/053089

§ 371 Date: Sep. 27, 2024

Related U.S. Application Data
(60) Provisional application No. 63/324,415, filed on Mar. 28, 2022.

(51) Int. Cl. H04W 72/21; H04W 72/23

(52) U.S. Cl. CPC H04W 72/21; H04W 72/23

(57) ABSTRACT

Apparatuses, methods, and systems are disclosed for a configuration based on configured grant (“CG”) uplink control information (“UCI”) (“CG-UCI”). One method includes initiating, at a user equipment (“UE”), a channel occupancy time (“COT”) by transmitting a first configured grant uplink (“UL”) transmission. The method includes including a first CG-UCI in the first configured grant UL transmission. The first CG-UCI indicates a first offset, a first duration, or a combination thereof. The method includes determining a first downlink (“DL”) transmission starting time based on the first offset, the first duration, or the combination thereof and a time that the first CG-UCI is sent. The method includes determining whether a delay budget for an UL application data unit (“ADU”), packet, or a combination thereof is less than a threshold value.

### FIELD

The subject matter disclosed herein relates generally to wireless communications and more particularly relates to a configuration based on configured grant (“CG”) uplink control information (“UCI”) (“CG-UCI”).

### BACKGROUND

In certain wireless communications networks, a channel occupancy time (“COT”) may be used. The COT may be configured in a number of ways.

### BRIEF SUMMARY

Methods for a configuration based on CG-UCI are disclosed. Apparatuses and systems also perform the functions of the methods. One embodiment of a method includes initiating, at a user equipment (“UE”), a COT by transmitting a first configured grant uplink (“UL”) transmission. In some embodiments, the method includes including a first CG-UCI in the first configured grant UL transmission. The first CG-UCI indicates a first offset, a first duration, or a combination thereof. In various embodiments, the method includes determining a first downlink (“DL”) transmission starting time based on the first offset, the first duration, or the combination thereof and a time that the first CG-UCI is sent. In certain embodiments, the method includes determining whether a delay budget for an UL application data unit (“ADU”), packet, or a combination thereof is less than a threshold value, and based on whether the delay budget for the UL ADU, packet, or the combination thereof being less than the threshold value. In some embodiments, the method includes determining a second DL transmission starting time, a second duration or a combination thereof based on: whether the delay budget for the UL ADU, packet, or the combination thereof is less than the threshold value; the first offset, the first duration, an un-transmitted portion of the UL ADU, packet, or the combination thereof, or a combination thereof. The second DL transmission starting time is different than the first DL transmission starting time, the second duration is different than the first duration, or a combination thereof, the UE does not expect to receive a DL transmission in the COT prior to the second DL transmission starting time; and the UE does not expect to receive the DL transmission in the COT for a duration larger than the second duration.

One apparatus for a configuration based on CG-UCI includes a user equipment. In some embodiments, the apparatus includes a processor that: initiates a COT by transmitting a first configured grant UL transmission; includes a first CG-UCI in the first configured grant UL transmission, wherein the first CG-UCI indicates a first offset, a first duration, or a combination thereof; determines a first DL transmission starting time based on the first offset, the first duration, or the combination thereof and a time that the first CG-UCI is sent; determines whether a delay budget for an UL ADU, packet, or a combination thereof is less than a threshold value, and based on whether the delay budget for the UL ADU, packet, or the combination thereof being less than the threshold value; and determines a second DL transmission starting time, a second duration or a combination thereof based on: whether the delay budget for the UL ADU, packet, or the combination thereof is less than the threshold value; the first offset, the first duration, an un-transmitted portion of the UL ADU, packet, or the combination thereof, or a combination thereof. The second DL transmission starting time is different than the first DL transmission starting time, the second duration is different than the first duration, or a combination thereof, the UE does not expect to receive a DL transmission in the COT prior to the second DL transmission starting time; and the UE does not expect to receive the DL transmission in the COT for a duration larger than the second duration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for a configuration based on CG-UCI;

FIG. 2 is a schematic block diagram illustrating one embodiment of an apparatus that may be used for a configuration based on CG-UCI;

FIG. 3 is a schematic block diagram illustrating one embodiment of an apparatus that may be used for a configuration based on CG-UCI;

FIG. 4 is a timing diagram illustrating one embodiment of a fixed frame period structure;

FIG. 5 is a timing diagram illustrating CG-UCI indicating two sets of offset and/or duration for sharing a UE-COT, wherein a first offset and/or a first duration is applicable to DL transmissions with a delay budget greater than a threshold value, and a second offset and/or a second duration is applicable to DL transmissions with a delay budget less than or equal to the threshold value;

FIG. 6 is a timing diagram illustrating a second CG-UCI that indicates a second offset and/or a second duration if the UE determines that an UL ADU and/or packet exceeds its delay budget; and

FIG. 7 is a flow chart diagram illustrating one embodiment of a method for a configuration based on CG-UCI.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

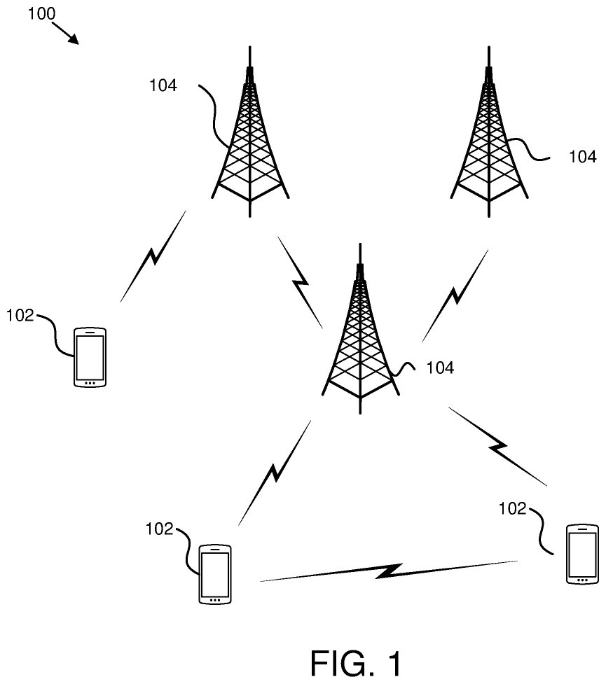

FIG. 1 depicts an embodiment of a wireless communication system 100 for a configuration based on CG-UCI. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-third generation partnership project (“3GPP”) gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (“OFDM”) modulation scheme on the DL and the remote units 102 transmit on the UL using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may initiate, at a UE, a COT by transmitting a first configured grant UL transmission. In some embodiments, the remote unit 102 may include a first CG-UCI in the first configured grant UL transmission. The first CG-UCI indicates a first offset, a first duration, or a combination thereof. In various embodiments, the remote unit 102 may determine a first DL transmission starting time based on the first offset, the first duration, or the combination thereof and a time that the first CG-UCI is sent. In certain embodiments, the remote unit 102 may determine whether a delay budget for an UL ADU, packet, or a combination thereof is less than a threshold value, and based on whether the delay budget for the UL ADU, packet, or the combination thereof being less than the threshold value. In some embodiments, the remote unit 102 may determine a second DL transmission starting time, a second duration or a combination thereof based on: whether the delay budget for the UL ADU, packet, or the combination thereof is less than the threshold value; the first offset, the first duration, an un-transmitted (e.g., not yet transmitted) portion of the UL ADU, packet, or the combination thereof; or a combination thereof. The second DL transmission starting time is different than the first DL transmission starting time, the second duration is different than the first duration, or a combination thereof; the UE does not expect to receive a DL transmission in the COT prior to the second DL transmission starting time; and the UE does not expect to receive the DL transmission in the COT for a duration larger than the second duration. Accordingly, the remote unit 102 may be used for a configuration based on CG-UCI.

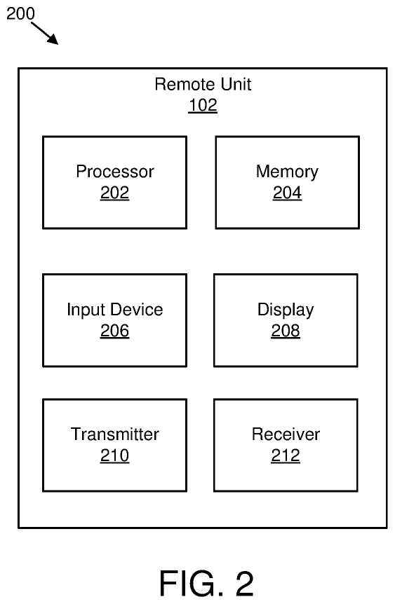

FIG. 2 depicts one embodiment of an apparatus 200 that may be used for a configuration based on CG-UCI. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202: initiates a COT by transmitting a first configured grant UL transmission; includes a first CG-UCI in the first configured grant UL transmission, wherein the first CG-UCI indicates a first offset, a first duration, or a combination thereof; determines a first DL transmission starting time based on the first offset, the first duration, or the combination thereof and a time that the first CG-UCI is sent; determines whether a delay budget for an UL ADU, packet, or a combination thereof is less than a threshold value, and based on whether the delay budget for the UL ADU, packet, or the combination thereof being less than the threshold value; and determines a second DL transmission starting time, a second duration or a combination thereof based on: whether the delay budget for the UL ADU, packet, or the combination thereof is less than the threshold value; the first offset, the first duration, an un-transmitted portion of the UL ADU, packet, or the combination thereof, or a combination thereof. The second DL transmission starting time is different than the first DL transmission starting time, the second duration is different than the first duration, or a combination thereof, the UE does not expect to receive a DL transmission in the COT prior to the second DL transmission starting time; and the UE does not expect to receive the DL transmission in the COT for a duration larger than the second duration.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

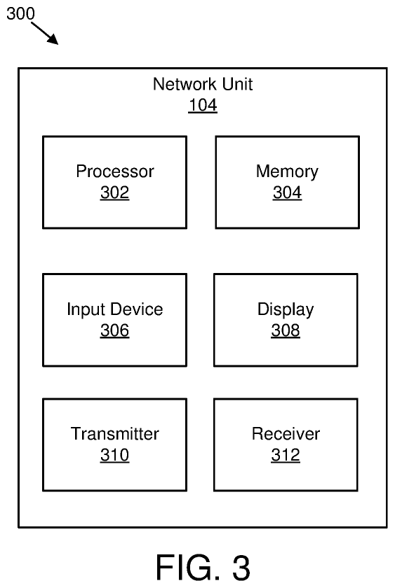

FIG. 3 depicts one embodiment of an apparatus 300 that may be used for a configuration based on CG-UCI. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

It should be noted that one or more embodiments described herein may be combined into a single embodiment.

In certain embodiments, a service-oriented design may have extended reality (“XR”) traffic characteristics (e.g., a) variable packet arrival rate: packets coming at 30-120 frames per second with some jitter, b) packets having variable and large packet size, c) bidirectional prediction image (“B”) and/or predicted image (“P”) (“B/P”)-frames being dependent on intra-coded (“I”)-frames, d) presence of multiple traffic and/or data flows such as pose and video scene in uplink) can enable more efficient (e.g., in terms of satisfying XR service requirements for a greater number of UEs, or in terms of UE power saving) for XR service delivery.

In some embodiments, a latency requirement for XR traffic at a radio access network (“RAN”) side (e.g., air interface) is modelled as packet delay budget (“PDB”). The PDB is a limited time budget for a packet to be transmitted over the air from a gNB to a UE. A delay budget can be also defined for an ADU, referred to as (“ADB”).

In various embodiments, if a scheduler is aware of delay budgets for a packet and/or ADU, a gNB may take this knowledge into account in scheduling transmissions. Described herein are mechanisms to take advantage of such delay budget awareness in an unlicensed spectrum.

In certain embodiments, for operation in unlicensed spectrum, especially in a semi-static channel access, downlink and uplink transmissions are allowed after a node such as a gNB or a UE has acquired a shared channel by a successful clear channel assessment, following a listen-before-talk (“LBT”) procedure. Procedures for gNBs and UEs acquiring a COT may be used for both dynamic and semi-static channel access mechanisms.

If a UE initiates a COT via a configured grant physical uplink shared channel (“PUSCH”) transmission (e.g., UL pose), the gNB can share the COT starting from an offset with respect to a time at which UCI containing ‘COT sharing information’ (e.g., referred to as CG-UCI) is detected for a duration. The offset and the duration are indicated via the ‘COT sharing information’.

In some embodiments, CG-UCI enhancements may be used to schedule ADUs and/or packets that are reaching their delay budget within a COT acquired by a UE: 1) CG-UCI contains at least two ‘COT sharing information’ fields or a field indicating at least two ‘COT sharing information’ lists (e.g., a row of a table for COT sharing combinations where each row can provide at least two ‘COT sharing information’), wherein a first ‘COT sharing information’ field indicates a first offset and duration, and a second ‘COT sharing information’ field indicates a second offset and duration, and the second offset is smaller than the first offset and/or the second duration is larger than the first duration—the gNB may schedule a transport block of a DL packet and/or ADU that is reaching its delay budget from the second offset in the COT and/or for the second duration; 2) CG-UCI indicates a set of offsets and durations (e.g., a row from a configured radio resource control (“RRC”) table), wherein the gNB can transmit DL signals in the periods derived according to the indicated set of offsets and durations, a first offset is smaller than a second offset, the second offset is smaller than a third offset, and so forth; 3) within the COT, the UE may transmit a second offset and duration in a second CG-UCI (or an UL transmission in general) different than a first offset and duration in a first CG-UCI, wherein the offsets and durations result in different DL transmission starting points and durations, at least under certain circumstances (e.g., after a first CG-UCI is sent, the UE determines that a delay budget for a first UL transmission (e.g., scheduled or to be scheduled (e.g., UL data is in UE's buffer) is exceeded or going to be exceeded, the UE would drop the first UL transmission, and in an upcoming CG-UCI the UE indicates to gNB a different (i.e., second) starting offset and duration; the second offset and duration can result in the (updated) DL transmission starting point to start earlier than that indicated by the first offset and/or the second duration to be larger than the indicated first duration); and/or 4) gNB can override and/or violate the CG-UCI indication, and start a DL transmission (e.g., determine the DL transmission starting point) earlier than the indicated starting offset in the CG-UCI under certain circumstances (e.g., if the gNB determines that a delay budget for a first UL transmission (e.g., scheduled or to be scheduled (UL data in UE's buffer) is exceeded or going to be exceeded).

In various embodiments, devices and/or network nodes such as gNBs operate in an unlicensed spectrum may be required to perform listen-before-talk (“LBT”) (e.g., also referred to as channel sensing) prior to being able to transmit in an unlicensed spectrum. If the device and/or network node performing LBT does not detect the presence of other signals in the channel, the medium and/or channel is considered for transmission. In a frame based equipment (“FBE”) mode of operation (e.g., which is intended for environments where the absence of other technologies is guaranteed e.g., by level of regulations, private premises policies, and so forth), the device and/or the network node performs LBT in an idle period and once acquired the channel and/or medium, the device and/or network node can communicate within the non-idle time of a fixed frame period duration (e.g., referred to as COT). In current specifications and/or regulations, the idle time is not shorter than the maximum of 5% of the fixed frame period (“FFP”) and 100 microseconds.

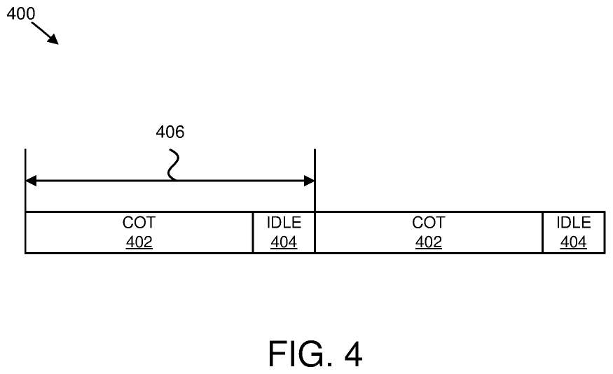

FIG. 4 is a timing diagram illustrating one embodiment of a fixed frame period structure 400. The fixed frame period structure 400 includes a COT 402 and idle 404 period that together extend for a fixed frame period 406.

In certain embodiments, a UE can perform channel sensing and access a channel if it senses the channel to be idle. UE initiated channel occupancy (“CO”) may be useful especially in low-latency applications, wherein having UL data to be sent in configured grant resources is allowed to initiate a CO.

In some embodiments, CG-UCI indicates an offset and/or duration which leads to a consistent DL starting position and duration for a DL transmission within a COT. So, different DL packets are not differentiated with respect to an earliest possible starting time instance within a UE-COT (e.g., based on packet delay budget).

HARQ-ACK related information and/or channel sharing related information may be indicated by the UE to the network via CG-UCI (see Table 1). In particular, if the UE is configured with higher layer parameter cg-RetransmissionTimer (e.g., to enable autonomous retransmissions of a configured PUSCH transmission in configured grant resources based on expiration of the CG-retransmission timer), the UE multiplexes CG-UCI in the CG-PUSCH transmission (see Tables 2 and 3). In some embodiments of this disclosure, a channel access priority class is indicated in the CG-UCI instead or along with offset and duration. For example, the CG-UCI in a COT may indicate two sets of (e.g., offset, duration, and channel access priority class), wherein depending on a delay budget for a packet/ADU, the gNB shares the COT: e.g., for a small delay budget, the gNB uses a smaller offset, a longer duration, a higher channel access priority, or a combination of thereof, and for a large delay budget, the gNB uses a larger offset, a shorter duration, a lower channel access priority, or a combination of thereof

TABLE 1
Mapping Order of CG-UCI Fields

| | |
|---|---|
| Field | Bitwidth |
| HARQ process number | 4 |
| Redundancy version | 2 |
| New data indicator | 1 |
| COT sharing information | [log₂C] if both higher layer parameter ul-toDL- |
| | COT-SharingED-Threshold and higher layer |
| | parameter cg-COT-SharingList are configured, |
| | or if both higher layer parameter ue- |
| | SemiStaticChannelAccessConfig and higher layer |
| | parameter cg-COT-SharingList are configured, |
| | where C is the number of combinations |
| | configured in cg-COT-SharingList; |
| | 1 if higher layer parameter ul-toDL-COT- |
| | SharingED-Threshold is not configured, and if |
| | higher layer parameter ue- |
| | SemiStaticChannelAccessConfig is not |
| | configured, and if higher layer parameter cg- |
| | COT-SharingOffset is configured; |
| | 0 otherwise; |
| | If a UE indicates COT sharing other than “no |
| | sharing” in a CG PUSCH within the UE's |
| | initiated COT, the UE should provide consistent |
| | COT sharing information in all the subsequent |
| | CG PUSCHs, if any, occurring within the same |
| | UE's initiated COT such that the same DL |
| | starting point and duration are maintained. |

In certain embodiments: CG-COT-Sharing-r16::=CHOICE {noCOT-Sharing-r16 NULL, cot-Sharing-r16 SEQUENCE {duration-r16 INTEGER (1..39), offset-r16 INTEGER (1..39), channelAccessPriority-r16 INTEGER (1..4)}

TABLE 2
cg-COT-SharingList
Indicates a table for COT sharing combinations. One row of the table can be set to noCOT-
Sharing to indicate that there is no channel occupancy sharing.
cg-COT-SharingOffset
Indicates the offset from the end of the slot where the COT sharing indication in UCI is
enabled where the offset in symbols is equal to 14*n, where n is the signaled value for cg-
COT-SharingOffset. Applicable when ul-toDL-COT-SharingED-Threshold-r16 is not
configured.

TABLE 3
CG-COT-Sharing Field Descriptions

channelAccessPriority
Indicates the Channel Access Priority Class that the gNB can assume when sharing the UE
initiated COT.
duration
Indicates the number of DL transmission slots within UE initiated COT.
offset
Indicates the number of DL transmission slots from the end of the slot where CG-UCI is
detected after which COT sharing can be used.

In various embodiments, XR is an umbrella term for different types of realities including: 1) virtual reality (“VR”) is a rendered version of a delivered visual and audio scene—the rendering is designed to mimic the visual and audio sensory stimuli of the real world as naturally as possible to an observer or user as they move within the limits defined by the application—virtual reality usually, but not necessarily, requires a user to wear a head mounted display (“HMD”) to completely replace the user's field of view with a simulated visual component, and to wear headphones, to provide the user with the accompanying audio—some form of head and motion tracking of the user in VR is usually also necessary to allow the simulated visual and audio components to be updated in order to ensure that, from the user's perspective, items and sound sources remain consistent with the user's movements—additional means to interact with the virtual reality simulation may be provided but are not strictly necessary; 2) augmented reality (“AR”) is when a user is provided with additional information or artificially generated items or content overlaid upon their current environment—such additional information or content will usually be visual and/or audible and their observation of their current environment may be direct, with no intermediate sensing, processing and rendering, or indirect, where their perception of their environment is relayed via sensors and may be enhanced or processed; and/or 3) mixed reality (“MR”) is an advanced form of AR where some virtual elements are inserted into the physical scene with the intent to provide the illusion that these elements are part of the real scene.

In certain embodiments, XR refers to all real-and-virtual combined environments and human-machine interactions generated by computer technology and wearables. It includes representative forms such as AR, MR, and VR and the areas interpolated among them. The levels of virtuality range from partially sensory inputs to fully immersive VR. A key aspect of XR is the extension of human experiences especially relating to the senses of existence (e.g., represented by VR) and the acquisition of cognition (e.g., represented by AR).”

In some embodiments, a latency requirement of XR traffic at an RAN side (e.g., air interface) is modelled as packet delay budget (“PDB”). The PDB is a limited time budget for a packet to be transmitted over the air from a gNB to a UE.

In various embodiments, for a given packet, a delay of a packet incurred in air interface is measured from a time that the packet arrives at the gNB to the time that it is successfully transferred to a UE. If the delay is larger than a given PDB for the packet, then the packet is said to violate PDB, otherwise the packet is said to be successfully delivered. The value of PDB may vary for different applications and traffic types, which can be 10-20 ms depending on an application. Applications can have a certain delay requirement on an ADU, that may not be adequately translated into packet delay budget requirements. For example, if the ADU delay budget (“ADB”) is 10 ms, then PDB can be set to 10 ms only if all packets of the ADU arrive at a fifth generation (“5G”) system at the same time. If the packets are spread out, then ADU delay budget is measured either in terms of the arrival of the first packet of the ADU or the last packet of the ADU. In either case, a given ADB will result in different PDB requirements on different packets of the ADU. It is observed that specifying the ADB to the 5G system can be beneficial.

In certain embodiments, many of the XR and CG use cases are characterized by quasi-periodic traffic (e.g., with possible jitter) with high data rate in DL (e.g., video steam) combined with the frequent UL (e.g., pose and/or control update) and/or UL video stream. Both DL and UL traffic are also characterized by relatively strict PDB. The set of anticipated XR and CG services has a certain variety and characteristics of the data streams (e.g., video) may change “on-the-fly”, while the services are running over NR. Therefore, additional information on the running services from higher layers, e.g., the quality of service (“QoS”) flow association, frame-level QoS, ADU-based QoS, XR specific QoS and so forth may be beneficial to facilitate informed choices of radio parameters. XR application awareness by UE and gNB may improve user experience, improve an NR system capacity in supporting XR services, and reduce the UE power consumption. An ADU may be the smallest unit of data that can be processed independently by an application (e.g., such as processing for handling out-of-order traffic data).

In some embodiments, there may be over-the-air synchronization as a mechanism (e.g., referred to as synchronized sharing) to provide more reliable communications for ultra-reliable low-latency communication (“URLLC”) applications in co-sited deployments using unlicensed spectrum. NR unlicensed (“U”) (“NR-U”) with synchronized sharing offers many benefits including reduced access latency and improved fairness to all access technologies using the same spectrum. With synchronized sharing in operation, coordinated multipoint (“CoMP”) may be used to improve either spectral efficiency or reliability. CoMP schedulers can adapt dynamically between the extremes of maximum spectral efficiency and maximum reliability from one scheduling period to the next, depending on the specific QoS requirements of the applications with data in transmission buffers. One NR-U network may be used to serve diverse applications such as mission-critical sensing and control, video surveillance, augmented or virtual reality (e.g., XR) and voice, each of which have different requirements for throughput, latency, jitter and packet loss or reliability. It should be noted that specific mechanisms for CG-UCI enhancements are described herein considering a remaining delay budget for DL and/or UL traffic and can work with an over-the-air synchronization mechanism.

In various embodiments, delay across different protocol stack layers from an XR server to a RAN may be labeled to improve scheduling packets that approach their latency limits. When the delay budget is over, the packet could be dropped at any particular layer or the priority of the packet could be re-adjusted (e.g., deprioritized). Described herein are specific mechanisms for CG-UCI enhancements considering the remaining delay budget for DL and/or UL traffic and can work with the proposed delay labeling mechanism. In certain embodiments, a gNB informs a UE about a delay budget for DL transmissions.

It should be noted that, as used here, a symbol, a slot, a subslot, and/or a transmission time interval (“TTI”) may be a time unit with a particular duration (e.g., symbol may be a fraction and/or percentage of an orthogonal frequency division multiplexing (“OFDM”) symbol length associated with a particular subcarrier spacing (“SCS”)). Moreover, an UL transmission (e.g., UL transmission burst) may include multiple transmissions (e.g., of the same and/or different priority if a priority is associated with the transmissions) potentially with gaps between the transmissions, wherein the gaps are short enough in duration to not necessitate performing a channel sensing and/or LBT operation between the transmissions.

In certain embodiments, sharing a COT implies that the device or node with which the COT is shared can forego an indicated or configured channel access category and/or type and instead apply and/or perform a channel access according to a category and/or type whose characteristic includes a generally shorter sensing period, an increased likelihood for the channel sensing to result in being able to transmit, or no required sensing period prior to transmission in the shared COT.

In a first set of embodiments, there may be CG-UCI enhancements.

In a first embodiment of the first set of embodiments, 1) a UE initiates a UE-COT by transmitting a configured grant UL transmission; 2) the UE includes a CG-UCI in the configured grant UL transmission in which a) the CG-UCI indicates at least a first offset and/or first duration, and a second offset and/or a second duration, b) wherein the second offset is less than or equal to the first offset, and/or the second duration is greater than or equal to the first duration; 3) wherein the gNB can transmit a first DL transmission (e.g., to the UE) in the CO: a) after the second offset from the time and/or slot the CG-UCI is detected for at most the second duration, if a remaining delay budget for the 1st DL transmission is less than or equal to a threshold value (or a priority of the DL transmission is greater than a threshold value), b) otherwise, after the first offset from the time and/or slot the CG-UCI is detected for at most the first duration.

In certain examples of the first embodiment of the first set of embodiments, the threshold value is: 1) signaled in the CG-UCI from a set of possible (e.g., configured) threshold levels—the UE may have UL data in the buffer for an UL ADU that might also approach its delay limit, so the UE can signal the threshold to balance between delay budget in UL and DL; 2) defined in a specification; 3) signaled by higher layers (e.g., RRC or medium access control (“MAC”) control element (“CE”) (“MAC-CE”) indication); 4) determined by an application layer; 5) determined based on a frame-per-second rate associated with the DL ADU and/or packet; 6) determined based on a DL and/or UL ADU payload size; and/or 7) determined based on a radio configuration of at least one of SCS, modulation and coding scheme (“MCS”), a number of transmission layers, and/or available physical resource blocks (“PRBs”) over the CO.

In various examples of the first embodiment of the first set of embodiments, the UE is expected to mute for a period of time after/before the 1st offset and/or a 2nd offset, wherein the period of time is: 1) fixed in a specification (e.g., can be SCS dependent); 2) configured by RRC; 3) indicated by downlink control information (“DCI”) or MAC-CE; and/or 4) determined based on the threshold value. In some examples of the first embodiment of the first set of embodiments, the second offset and/or second duration leads to a longer CO opportunity than the first offset and/or first duration. In certain examples of the first embodiment of the first set of embodiments, the UE is not expected to receive a physical downlink shared channel (“PDSCH”) with a remaining delay budget that is more than the threshold value before the first offset. In some examples of the first embodiment of the first set of embodiments, the UE is not expected to receive a PDSCH before the 1^{st} offset if the remaining delay budget (or priority) can be accommodated in DL starting point and duration associated with the first offset and duration within the same UE initiated COT. In various examples of the first embodiment of the first set of embodiments, if a DL transmission is not associated with a remaining delay budget or if the UE (or gNB) is not able to determine a remaining delay budget for a DL transmission, the DL transmission is not expected to be received prior to the first offset.

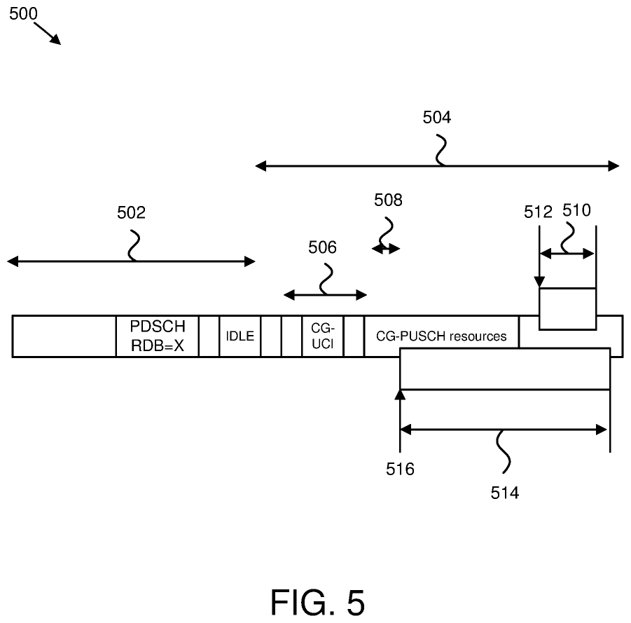

FIG. 5 is a timing diagram 500 illustrating CG-UCI indicating two sets of offset and/or duration for sharing a UE-COT, wherein a first offset and/or a first duration is applicable to DL transmissions with a delay budget greater than a threshold value, and a second offset and/or a second duration is applicable to DL transmissions with a delay budget less than or equal to the threshold value. The timing diagram 500 illustrates a first COT 502 and a second COT 504. During the second COT 504, there is a CG-PUSCH 506, and a UE mute time 508. Further, there is a first duration 510 from a first DL starting point 512, and a second duration 514 from a second DL starting point 516.

In a second embodiment of the first set of embodiments: 1) the UE initiates a UE-COT by transmitting a configured grant UL transmission; 2) the UE includes a CG-UCI in the configured grant UL transmission (e.g., the CG-UCI indicates a first offset and/or a first duration); 3) for a first DL transmission, the gNB determines a second offset and/or a second duration based on the first offset and/or the first duration and the remaining delay budget for the first DL transmission; 4) for a second DL transmission, the gNB determines a third offset and/or a third duration based on the first offset and/or the first duration and the remaining delay budget for the second DL transmission; 5) the gNB transmits the first DL transmission (e.g., to the UE) in the COT after the second offset from the time and/or slot the CG-UCI is detected; 6) the gNB transmits the second DL transmission (e.g., to the UE) in the COT after the third offset from the time and/or slot the CG-UCI is detected; and/or 7) the third offset is smaller than the second offset, and/or the third duration is greater than the second duration, and the remaining delay budget for the first DL transmission is greater than the remaining delay budget for the second DL transmission.

In certain examples of the second embodiment of the first set of embodiments: 1) the UE is expected to mute for a period of time after/before the first offset; 2) the third offset and/or third duration is determined to be the first offset and/or the first duration and the second offset is determined to be the first offset plus ‘X’>=0, where ‘X’ is determined by the gNB from a (e.g., configured or specified) lookup table mapping remaining delay budget values to ‘X’ values; 3) the third offset is determined to be zero or a fixed and/or configured number of slots, symbols, and/or time units, and the third duration is until the end of the COT and the second offset and/or second duration is determined to be the first offset and/or first duration); 4) the CG-UCI indicates whether DL transmissions with remaining delay budget less than or equal to a threshold value may be transmitted with zero and/or small (e.g., fixed, configured, and/or MAC-CE indicated) offset with respect to the CG-UCI is allowed in the COT (e.g., in one COT the associated CG-UCI may allow and, in another COT, the corresponding CG-UCI may not allow such DL transmissions); and/or 5) in a previous COT (e.g., at most certain time before the start of the COT), the UE is indicated with a remaining delay budget for a DL ADU and/or packet, or a remaining delay budget for a DL ADU and/or packet is smaller than a threshold. If the UE has not received such indication, the third offset and/or the third duration is not determined and/or not applicable. Moreover, if the UE has received such indication, the offset and/or the duration in the CG-UCI is not applicable or CG-UCI is not included in the configured grant UL transmission. Further, at least if such indication is acknowledged by the UE (e.g., in a prior COT) where the UE has been scheduled for a PDSCH transmission wherein the DCI indicates information regarding the remaining delay budget of a DL ADU and/or packet. If the PDSCH transmission is acknowledged, then, in the UE-COT, the CG-UCI is not applicable or CG-UCI is not included in the configured grant UL transmission. The indication may be provided via a group-common DCI with multiple fields, wherein each field indicates information of remaining delay budget for a DL ADU and/or packet for a UE or a group of UEs.

In a third embodiment of the first set of embodiments, 1) a first device initiates a COT and subsequently transmits a first transmission within the initiated CO; 2) the first transmission of the first device includes control information; 3) the control information indicates at least a first offset and/or a first duration, and a second offset and/or a second duration; 4) the second offset is less than or equal to the first offset, and/or the second duration is greater than the first duration; 5) a second device transmits a second transmission (e.g., to the first device) in the CO, a) after the second offset from the time and/or slot in which the control information is detected for at most the second duration if a remaining delay budget for the second transmission is less than or equal to a threshold value (or a priority of the second transmission is greater than a threshold value), b) otherwise, after the first offset from the time and/or slot in which the control information is detected for at most the first duration.

According to the third embodiment of the first set of embodiments: 1) the first device may be a UE, a gNB, a repeater, and/or a smart device; and/or 2) the second device may be a UE, a gNB, a repeater, and/or a smart device. Moreover, the first transmission by the first device may be: 1) a downlink transmission, such as dynamically indicated by a DCI, especially if the first device is a gNB; 2) a downlink transmission, such as indicated by an semi-persistent scheduling (“SPS”) configuration and/or SPS activation command by RRC and/or DCI, especially if the first device is a gNB; 3) an uplink transmission, such as dynamically indicated by a DCI, especially if the first device is a UE; 4) an uplink transmission, such as indicated by a CG configuration and/or CG activation command by RRC and/or DCI, especially if the first device is a UE; and/or 5) a sidelink transmission, such as indicated by sidelink control information (“SCI”), especially if the first device is a UE.

In certain embodiments, the control information may be part of or indicated by: 1) a DCI message, especially if the first transmission is a downlink transmission; 2) a UCI message, especially if the first transmission is an uplink transmission; 3) a CG-UCI message if the first transmission is an uplink CG transmission; and/or 4) an SCI message, especially if the first transmission is a sidelink transmission. Further, in some embodiments, the second transmission by the second device may be: 1) a downlink transmission, such as dynamically indicated by a DCI, especially if the second device is a gNB; 2) a downlink transmission, such as indicated by an SPS configuration/activation by RRC and/or DCI, especially if the second device is a gNB; 3) an uplink transmission, such as dynamically indicated by a DCI, especially if the second device is a UE; 4) an uplink transmission, such as indicated by a CG configuration/activation by RRC and/or DCI, especially if the second device is a UE; and/or 5) a sidelink transmission, such as indicated by an SCI, especially if the second device is a UE.

In a fourth embodiment of the first set of embodiments: 1) a first device initiates a COT and subsequently transmits a first transmission within the initiated CO; 2) the first transmission of the first device includes control information, wherein the control information indicates a first offset and/or a first duration; 3) for a second transmission, a second device determines a second offset and/or a second duration based on the first offset and/or the first duration, and the remaining delay budget for the second transmission; 4) for a third transmission, the second device determines a third offset and/or a third duration based on the first offset and/or the first duration, and the remaining delay budget for the third transmission; 5) the second device transmits the second transmission (e.g., to the first device) in the COT after the second offset from the time and/or slot in which the control information is detected; 6) the second device transmits the third transmission (e.g., to the first device) in the COT after the third offset from the time and/or slot in which the control information is detected; and/or 7) the third offset is less than or equal to the second offset, and/or the third duration is greater than the second duration, and the remaining delay budget for the second transmission is greater than the remaining delay budget for the third transmission.

According to the fourth embodiment of the first set of embodiments: 1) the first device may be a UE, a gNB, a repeater, a smart device; and/or 2) the second device may be a UE, a gNB, a repeater, a smart device. In some embodiments, the first transmission by the first device may be: 1) a downlink transmission, such as dynamically indicated by a DCI, especially if the first device is a gNB; 2) a downlink transmission, such as indicated by an SPS configuration/activation by RRC and/or DCI, especially if the first device is a gNB; 3) an uplink transmission, such as dynamically indicated by a DCI, especially if the first device is a UE; 4) an uplink transmission, such as indicated by a CG configuration/activation by RRC and/or DCI, especially if the first device is a UE; and/or 5) a sidelink transmission, such as indicated by an SCI, especially if the first device is a UE.

In various embodiments, the control information may be part of or indicated by: 1) a DCI message, especially if the first transmission is a downlink transmission; 2) a UCI message, especially if the first transmission is an uplink transmission; 3) a CG-UCI message if the first transmission is an uplink CG transmission; and/or 4) an SCI message, especially if the first transmission is a sidelink transmission. In certain embodiments, the second transmission by the second device, and the third transmission by the second device, each may be: 1) a downlink transmission, such as dynamically indicated by a DCI, especially if the second device is a gNB; 2) a downlink transmission, such as indicated by an SPS configuration/activation by RRC and/or DCI, especially if the second device is a gNB; 3) an uplink transmission, such as dynamically indicated by a DCI, especially if the second device is a UE; 4) an uplink transmission, such as indicated by a CG configuration/activation by RRC and/or DCI, especially if the second device is a UE; and/or 5) a sidelink transmission, such as indicated by an SCI, especially if the second device is a UE.

In a second set of embodiments, there may be CG-UCI overriding.

In a first embodiment of the second set of embodiments: 1) the UE initiates a UE-COT by transmitting a first configured grant UL transmission; 2) the UE includes a first CG-UCI in the first configured grant UL transmission in which the first CG-UCI indicates a first offset and/or a first duration, and the gNB can share the COT starting from the first offset with respect to the time the CG-UCI is detected (e.g., referred to as first DL starting point) for the first duration; and/or 3) the UE determines that a delay budget for an UL ADU and/or packet is exceeded, in response to such determination: a) the UE drops the remainder of the UL ADU and/or UL packet transmission, and b) the UE performs one or both of the following: in an upcoming (e.g., second) CG-UCI, the UE indicates to gNB a second offset and/or a second duration resulting in a second DL starting point, wherein the first DL starting point and the second starting point are different and/or the 1st duration and the 2nd duration are different; and/or the UE indicates to a gNB that a delay budget associated with the UL ADU and/or packet is exceeded.

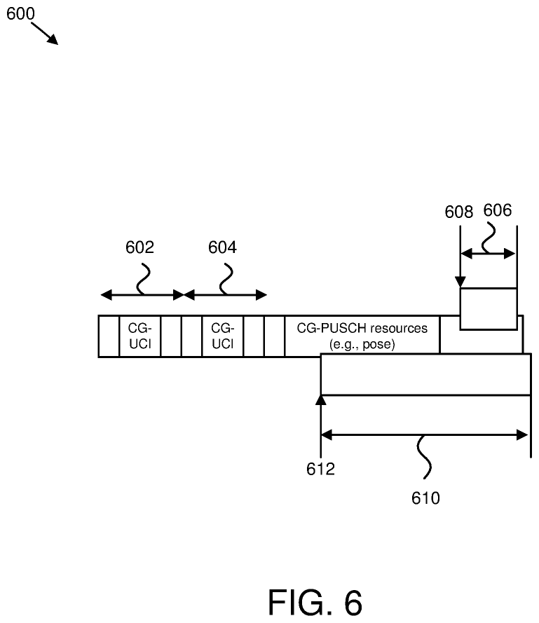

FIG. 6 is a timing diagram 600 illustrating a second CG-UCI that indicates a second offset and/or a second duration if the UE determines that an UL ADU and/or packet exceeds its delay budget. The timing diagram 600 illustrates a first CG-PUSCH 602, and a second CG-PUSCH 604. Further, there is a first duration 606 from a first DL starting point 608, and a second duration 610 from a second DL starting point 612.

In certain examples of the first embodiment of the second set of embodiments: 1) a CG-UCI at least includes two sub-fields: a) a 1st sub-field indicates if a delay budget is exceeded, b) if the 1st sub-field indicates a delay budget is exceeded, the 2nd sub-field indicates an ADU-identifier (“ID”), packet-ID, and/or hybrid automatic repeat request (“HARQ”)-ID associated with the ADU and/or packet for which the delay budget is exceeded, c) if the 1st sub-field indicates a delay budget is not exceeded, c1) the 2nd sub-field is not included in the CG-UCI, c2) the 2nd sub-field is included in the CG-UCI, and a pre-determined value is indicated in the 2nd sub-field, c3) the 2nd sub-field indicates a remaining delay budget or c4) the gNB ignores the value of the 2nd sub-field; 2) a CG-UCI (e.g., the CG-UCI) indicates to the gNB the remaining delay budget for an UL ADU, packet, and/or HARQ process; and/or 2a) a HARQ-process-ID or an ADU-ID is also included in CG-UCI to associate the remaining delay budget to the corresponding ADU, packet, and/or HARQ-process; 3) the 2nd DL starting point is earlier than the 1st DL starting point and/or the 2nd duration is larger than the 1st duration; 4) the second DL starting point is at least a certain time earlier than the first DL starting point in which the certain time is ‘m’ slots (e.g., the first DL starting point is in slot ‘k’, and the second DL starting point is in slot ‘k+m’), wherein ‘m’ is configured by higher layer signaling; 5) the second duration is at least a certain time greater than the first duration, the certain time is ‘d’ slots, wherein ‘d’ is configured by higher layer signaling; 6) the 2nd CG-UCI is at least ‘T1’ time units after the 1st CG-CUI giving gNB enough time to modify scheduling decisions in which ‘T1’ depends on at least one of SCS, PDSCH processing time, and PUSCH preparation time, and ‘T1’ is indicated via higher layer signaling; and/or 7) the UE determines that a delay budget for an UL ADU and/or packet is less than or equal to a threshold value, and adjusts a DL starting point in a later CG-UCI. The threshold value is indicated by higher layer signaling or by a DCI indication.

In a second embodiment of the second set of embodiments: 1) the UE initiates a UE-COT by transmitting a configured grant UL transmission; 2) the UE includes a CG-UCI in the configured grant UL transmission in which the CG-UCI indicates an offset and/or a duration the gNB can share the COT starting from the offset with respect to the time the CG-UCI is detected (e.g., referred to as the DL starting point) for the duration; and/or 3) the gNB determines that a delay budget for a DL ADU and/or packet or an UL ADU and/or packet is exceeded or going to be exceeded. In response to such determination, one or more of the following is performed: 1) the gNB starts a DL transmission earlier than the indicated starting offset in the CG-UCI—the duration of the DL transmission can exceed the duration indicated in the CG-UCI; and/or 2) the UE cancels one or more of upcoming poses associated with the ADU and/or packet. If an ADU (e.g., DL ADU) is no longer useful, a corresponding pose may not be useful and/or the UE may skip transmitting every other UL poses or down-samples the UL poses according to a down-sampling pattern, wherein the down-sampling pattern may depend on the frame per second (“FPS”) of the XR DL traffic or other application parameters (e.g., pose delta/change with respect to a previous/reference pose).

In certain implementations of the second embodiment of the second set of embodiments: 1) the gNB indicates to the UE the number of upcoming UL poses to be canceled; 2) the gNB can indicate a pose cancellation or down-sampling command to the UE (the command may include a threshold for a pose difference with respect to a previous/reference pose, wherein if the pose is not that different (based on the threshold, and a defined measure for calculating the difference) form the previous/reference pose, the pose will not be transmitted), wherein the command can be sent in another component carrier which is different than the component carrier in which the pose is intended to be transmitted; 3) the UE may be configured with one or more time instances and/or offsets from the beginning of the COT or determined based on (e.g., duration and/or location) of one or more configured grant resources, the UE may mute for a certain time prior/after each of the one or more time instances and/or offsets to allow gNB to grab the channel and/or share the CO in case it wants to send some DL data or send control information; 4) the UE determines a set of UL poses to be canceled based on determining a delay budget of the ADU and/or packet being exceeded. The UE indicates the set of UL poses to be canceled or a parameter of the set of UL poses (e.g., number of cancelled UL poses and the first or the last cancelled UL pose index). The indication can be a SLIV-like indication, where a starting symbol and length for time domain resource allocation is indicated, wherein the UL poses lying in the time-domain resources from the indicated starting symbol for a duration of the indicated length are cancelled.

In a third embodiment of the second set of embodiments: 1) a first device initiates a COT and subsequently transmits a first transmission within the initiated CO; 2) the first transmission of the first device includes a first control information to a second device; 3) the first control information indicates at least a first offset and/or duration resulting in a first transmission starting point, wherein the second device can start transmitting (e.g., to the first device) from the first transmission starting point for a maximum duration of the first duration; 4) the first device determines that a delay budget for an ADU and/or packet in its buffer is exceeded, in response to such determination: a) the first device drops the remainder of the ADU and/or packet transmission, and b) the first device performs one or both of the following: b1) in a second control information, the first device indicates to the second device a second offset and/or duration resulting in a 2nd transmission starting point, wherein the 1st transmission starting point and the 2nd transmission starting point are different and/or the 1st duration and the 2nd duration are different; and/or b2) the first device indicates to the second device that a delay budget associated with an ADU and/or packet is exceeded, wherein the second control information is indicated after the first control information; and/or 5) the second device transmits a second transmission (e.g., to the first device) in the CO after the 2nd offset from the time and/or slot in which the second control information is detected for at most the 2nd duration.

According to the third embodiment of the second set of embodiments: 1) the first device may be a UE, a gNB, a repeater, a smart device; and/or 2) the second device may be a UE, a gNB, a repeater, a smart device. Moreover, in certain examples of the third embodiment of the second set of embodiments the first transmission by the first device may be: 1) a downlink transmission, such as dynamically indicated by a DCI, especially if the first device is a gNB; 2) a downlink transmission, such as indicated by an SPS (semi-persistent scheduling) configuration and/or SPS activation command by RRC and/or DCI, especially if the first device is a gNB; 3) an uplink transmission, such as dynamically indicated by a DCI, especially if the first device is a UE; 4) an uplink transmission, such as indicated by a CG configuration and/or CG activation command by RRC and/or DCI, especially if the first device is a UE; and/or 5) a sidelink transmission, such as indicated by an SCI, especially if the first device is a UE.

Further, in some examples of the third embodiment of the second set of embodiments the first and the second control information may be part of or indicated by: 1) a DCI message, especially if the first transmission is a downlink transmission; 2) a UCI message, especially if the first transmission is an uplink transmission; 3) a CG-UCI message if the first transmission is an uplink CG transmission; and/or 4) an SCI message, especially if the first transmission is a sidelink transmission. In various examples of the third embodiment of the second set of embodiments the second transmission by the second device may be: 1) a downlink transmission, such as dynamically indicated by a DCI, especially if the second device is a gNB; 2) a downlink transmission, such as indicated by an SPS configuration/activation by RRC and/or DCI, especially if the second device is a gNB; 3) an uplink transmission, such as dynamically indicated by a DCI, especially if the second device is a UE; 4) an uplink transmission, such as indicated by a CG configuration/activation by RRC and/or DCI, especially if the second device is a UE; and/or 5) a sidelink transmission, such as indicated by an SCI, especially if the second device is a UE.

In a fourth embodiment of the second set of embodiments: 1) a first device initiates a COT and subsequently transmits a first transmission within the initiated CO; 2) the first transmission of the first device includes control information, a) the control information indicates a 1st offset and/or a 1st duration corresponding to a first transmission starting point allowing a second device to transmit in the initiated CO after the 1st transmission starting point and for a maximum duration of the first duration; 3) the second device determines that a delay budget for an ADU and/or packet is exceeded or going to be exceeded, a) in response to such determination, one or more of the following is performed: a1) the second device starts a second transmission earlier than the first transmission starting point—the duration of the second transmission can exceed the first duration, a2) the first device cancels one or more of upcoming transmissions associated with the ADU and/or packet; 4) the second device transmits a second transmission (e.g., to the first device) in the COT after a 2nd offset from the time/slot in which the control information is detected; and/or 5) the second device transmits a third transmission (e.g., to the first device) in the COT after a 3rd offset from the time and/or slot in which the control information is detected, wherein the 3^{rd} offset is smaller than the 2nd offset, and/or the 3rd duration is larger than the 2nd duration, and the remaining delay budget for the second transmission is larger than the remaining delay budget for the third transmission.

According to the fourth embodiment of the second set of embodiments: 1) the first device may be a UE, a gNB, a repeater, a smart device; and/or 2) the second device may be a UE, a gNB, a repeater, a smart device. In certain examples of the fourth embodiment of the second set of embodiments the first transmission by the first device may be: 1) a downlink transmission, such as dynamically indicated by a DCI, especially if the first device is a gNB; 2) a downlink transmission, such as indicated by an SPS configuration/activation by RRC and/or DCI, especially if the first device is a gNB; 3) an uplink transmission, such as dynamically indicated by a DCI, especially if the first device is a UE; 4) an uplink transmission, such as indicated by a CG configuration/activation by RRC and/or DCI, especially if the first device is a UE; and/or 5) a sidelink transmission, such as indicated by an SCI, especially if the first device is a UE.

In some examples of the fourth embodiment of the second set of embodiments the control information may be part of or indicated by: 1) a DCI message, especially if the first transmission is a downlink transmission; 2) a UCI message, especially if the first transmission is an uplink transmission; 3) a CG-UCI message if the first transmission is an uplink CG transmission; and/or 4) an SCI message, especially if the first transmission is a sidelink transmission. In various examples of the fourth embodiment of the second set of embodiments the second transmission by the second device, and the third transmission by the second device, each may be: 1) a downlink transmission, such as dynamically indicated by a DCI, especially if the second device is a gNB; 2) a downlink transmission, such as indicated by an SPS configuration/activation by RRC and/or DCI, especially if the second device is a gNB; 3) an uplink transmission, such as dynamically indicated by a DCI, especially if the second device is a UE; 4) an uplink transmission, such as indicated by a CG configuration/activation by RRC and/or DCI, especially if the second device is a UE; and/or 5) a sidelink transmission, such as indicated by an SCI, especially if the second device is a UE.

As used herein, an offset and/or duration may be reported in some embodiments in terms of symbols and/or in terms of slots.

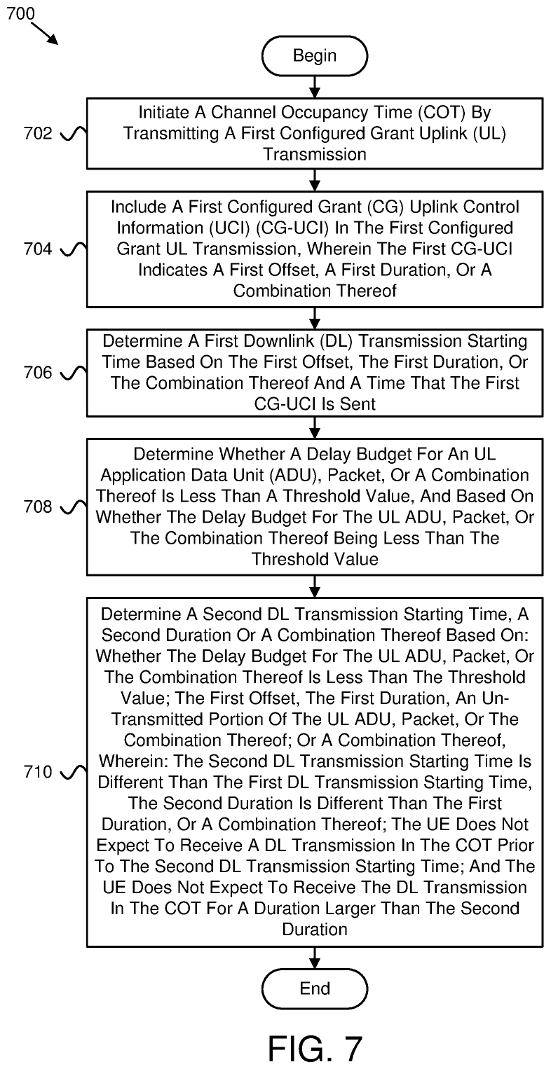

FIG. 7 is a flow chart diagram illustrating one embodiment of a method 700 for a configuration based on CG-UCI. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes initiating 702, at a UE, a COT by transmitting a first configured grant UL transmission. In some embodiments, the method 700 includes including 704 a first CG-UCI in the first configured grant UL transmission. The first CG-UCI indicates a first offset, a first duration, or a combination thereof. In various embodiments, the method 700 includes determining 706 a first DL transmission starting time based on the first offset, the first duration, or the combination thereof and a time that the first CG-UCI is sent. In certain embodiments, the method 700 includes determining 708 whether a delay budget for an UL ADU, packet, or a combination thereof is less than a threshold value, and based on whether the delay budget for the UL ADU, packet, or the combination thereof being less than the threshold value. In some embodiments, the method 700 includes determining 710 a second DL transmission starting time, a second duration or a combination thereof based on: whether the delay budget for the UL ADU, packet, or the combination thereof is less than the threshold value; the first offset, the first duration, an un-transmitted portion of the UL ADU, packet, or the combination thereof; or a combination thereof. The second DL transmission starting time is different than the first DL transmission starting time, the second duration is different than the first duration, or a combination thereof: the UE does not expect to receive a DL transmission in the COT prior to the second DL transmission starting time; and the UE does not expect to receive the DL transmission in the COT for a duration larger than the second duration.

In certain embodiments, a second CG-UCI is included in a second configured grant UL transmission, and the second CG-UCI indicates a second offset, the second duration, or a combination thereof. In some embodiments, the second CG-UCI is at least a certain time after the first CG-CUI. In various embodiments, the second DL transmission starting time is at least a certain time earlier than the first DL transmission starting time.

In one embodiment, the second duration is at least a certain time greater than the first duration. In certain embodiments, the threshold value is configured by higher layer signaling. In some embodiments, the delay budget for the UL ADU, packet, or the combination thereof is exceeded.

In various embodiments, the method 700 further comprises dropping the remainder of the UL ADU, packet, or the combination thereof transmission. In one embodiment, the second DL transmission starting time is at or later than a time at which the remainder of the UL ADU, packet, or the combination thereof transmission is dropped. In certain embodiments, the method 700 further comprises indicating to a network device that the delay budget is exceeded, that the remainder of the UL ADU, packet, or the combination thereof transmission is to be dropped, or a combination thereof.

In some embodiments, the second DL transmission starting time, the second duration, or a combination thereof is further determined based on a time at which a remainder of a transmission of the UL ADU, packet, or the combination thereof is dropped. In various embodiments, the method 700 further comprises determining a set of UL extended reality (XR) poses to be canceled based on a delay budget for a DL ADU, packet, or a combination thereof, an UL ADU, packet, or a combination thereof, or a combination thereof being exceeded.

In one embodiment, the method 700 further comprises indicating the set of UL XR poses to a network device. In certain embodiments, the method further comprises receiving an indication that the delay budget for a DL ADU, packet, or a combination thereof is exceeded or to be exceeded within a certain time, wherein, in response to the indication, the method further comprises determining a set of UL extended reality (XR) poses to be canceled, muted, or a combination thereof.

In one embodiment, an apparatus comprises a UE. The apparatus further comprises: a processor that: initiates a COT by transmitting a first configured grant UL transmission; includes a first CG-UCI in the first configured grant UL transmission, wherein the first CG-UCI indicates a first offset, a first duration, or a combination thereof, determines a first DL transmission starting time based on the first offset, the first duration, or the combination thereof and a time that the first CG-UCI is sent; determines whether a delay budget for an UL ADU, packet, or a combination thereof is less than a threshold value, and based on whether the delay budget for the UL ADU, packet, or the combination thereof being less than the threshold value; and determines a second DL transmission starting time, a second duration or a combination thereof based on: whether the delay budget for the UL ADU, packet, or the combination thereof is less than the threshold value; the first offset, the first duration, an un-transmitted portion of the UL ADU, packet, or the combination thereof; or a combination thereof, wherein: the second DL transmission starting time is different than the first DL transmission starting time, the second duration is different than the first duration, or a combination thereof; the UE does not expect to receive a DL transmission in the COT prior to the second DL transmission starting time; and the UE does not expect to receive the DL transmission in the COT for a duration larger than the second duration.

In certain embodiments, a second CG-UCI is included in a second configured grant UL transmission, and the second CG-UCI indicates a second offset, the second duration, or a combination thereof.

In some embodiments, the second CG-UCI is at least a certain time after the first CG-CUI.

In various embodiments, the second DL transmission starting time is at least a certain time earlier than the first DL transmission starting time.

In one embodiment, the second duration is at least a certain time greater than the first duration.

In certain embodiments, the threshold value is configured by higher layer signaling.

In some embodiments, the delay budget for the UL ADU, packet, or the combination thereof is exceeded.

In various embodiments, the processor drops the remainder of the UL ADU, packet, or the combination thereof transmission.

In one embodiment, the second DL transmission starting time is at or later than a time at which the remainder of the UL ADU, packet, or the combination thereof transmission is dropped.

In certain embodiments, the processor indicates to a network device that the delay budget is exceeded, that the remainder of the UL ADU, packet, or the combination thereof transmission is to be dropped, or a combination thereof.

In some embodiments, the second DL transmission starting time, the second duration, or a combination thereof is further determined based on a time at which a remainder of a transmission of the UL ADU, packet, or the combination thereof is dropped.

In various embodiments, the processor determines a set of UL extended reality (XR) poses to be canceled based on a delay budget for a DL ADU, packet, or a combination thereof, an UL ADU, packet, or a combination thereof, or a combination thereof being exceeded.

In one embodiment, the processor indicates the set of UL XR poses to a network device.

In certain embodiments, the apparatus further comprises a receiver that receives an indication that the delay budget for a DL ADU, packet, or a combination thereof is exceeded or to be exceeded within a certain time, wherein, in response to the indication, the processor determines a set of UL extended reality (XR) poses to be canceled, muted, or a combination thereof.

In one embodiment, a method at a UE comprises: initiating a COT by transmitting a first configured grant UL transmission; including a first CG-UCI in the first configured grant UL transmission, wherein the first CG-UCI indicates a first offset, a first duration, or a combination thereof, determining a first DL transmission starting time based on the first offset, the first duration, or the combination thereof and a time that the first CG-UCI is sent; determining whether a delay budget for an UL ADU, packet, or a combination thereof is less than a threshold value, and based on whether the delay budget for the UL ADU, packet, or the combination thereof being less than the threshold value; and determining a second DL transmission starting time, a second duration or a combination thereof based on: whether the delay budget for the UL ADU, packet, or the combination thereof is less than the threshold value; the first offset, the first duration, an un-transmitted portion of the UL ADU, packet, or the combination thereof, or a combination thereof, wherein: the second DL transmission starting time is different than the first DL transmission starting time, the second duration is different than the first duration, or a combination thereof, the UE does not expect to receive a DL transmission in the COT prior to the second DL transmission starting time; and the UE does not expect to receive the DL transmission in the COT for a duration larger than the second duration.

In certain embodiments, a second CG-UCI is included in a second configured grant UL transmission, and the second CG-UCI indicates a second offset, the second duration, or a combination thereof.

In some embodiments, the second CG-UCI is at least a certain time after the first CG-CUI.

In various embodiments, the second DL transmission starting time is at least a certain time earlier than the first DL transmission starting time.

In one embodiment, the second duration is at least a certain time greater than the first duration.

In certain embodiments, the threshold value is configured by higher layer signaling.

In some embodiments, the delay budget for the UL ADU, packet, or the combination thereof is exceeded.

In various embodiments, the method further comprises dropping the remainder of the UL ADU, packet, or the combination thereof transmission.

In one embodiment, the second DL transmission starting time is at or later than a time at which the remainder of the UL ADU, packet, or the combination thereof transmission is dropped.

In certain embodiments, the method further comprises indicating to a network device that the delay budget is exceeded, that the remainder of the UL ADU, packet, or the combination thereof transmission is to be dropped, or a combination thereof.

In some embodiments, the second DL transmission starting time, the second duration, or a combination thereof is further determined based on a time at which a remainder of a transmission of the UL ADU, packet, or the combination thereof is dropped.

In various embodiments, the method further comprises determining a set of UL extended reality (XR) poses to be canceled based on a delay budget for a DL ADU, packet, or a combination thereof, an UL ADU, packet, or a combination thereof, or a combination thereof being exceeded.

In one embodiment, the method further comprises indicating the set of UL XR poses to a network device.

In certain embodiments, the method further comprises receiving an indication that the delay budget for a DL ADU, packet, or a combination thereof is exceeded or to be exceeded within a certain time, wherein, in response to the indication, the method further comprises determining a set of UL extended reality (XR) poses to be canceled, muted, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
transmit a first configured grant (CG) uplink (UL) transmission, wherein the first CG UL transmission initiates a channel occupancy time (COT), wherein;
the first CG UL transmission includes a first CG uplink control information (UCI) (CG-UCI), and wherein the first CG-UCI indicates a first offset, a first duration, or a combination thereof;
determine a first starting time for downlink (DL) transmission based on the first offset, the first duration, or the combination thereof and a time that the first CG-UCI is transmitted;
determine whether a delay budget for an UL application data unit (ADU), packet, or a combination thereof is less than a threshold value; and
determine a second starting time for DL transmission, a second duration or a combination thereof based on:
whether the delay budget is less than the threshold value;
the first offset, the first duration, an un-transmitted portion of the UL ADU, packet, or the combination thereof;
or a combination thereof, wherein:
the second starting time is different than the first starting time, the second duration is different than the first duration, or a combination thereof;
the UE does not expect to receive transmission in the COT prior to the second starting time; and
the UE does not expect to receive DL transmission in the COT for a duration larger than the second duration.

2. The UE of claim 1, wherein a second CG-UCI is included in a second CG UL transmission, and the second CG-UCI indicates a second offset, the second duration, or a combination thereof.

3. The UE of claim 2, wherein the secondCG UL transmission occurs at least a certain time after the first CG UL transmission.

4. The UE of claim 1, wherein the second starting time occurs at least a certain time earlier than the first starting time.

5. The UE of claim 1, wherein the second duration is greater than the first duration.

6. The UE of claim 1, wherein the threshold value is configured by higher layer signaling.

7. The UE of claim 1, wherein the delay budget is exceeded.

8. The UE of claim 7, wherein the at least one processor is configured to cause the UE to drop a transmission of a remainder of the UL ADU, packet, or the combination thereof.

9. The UE of claim 8, wherein the second starting time is at or later than a time at which the transmission of the remainder of the UL ADU, packet, or the combination thereof is dropped.

10. The UE of claim 8, wherein the at least one processor is configured to cause the UE to indicate to a network device that the delay budget is exceeded, that the transmission of the remainder of the UL ADU, packet, or the combination thereof is to be dropped, or a combination thereof.

11. The UE of claim 8, wherein the second starting time, the second duration, or a combination thereof is further based on a time at which the transmission of the remainder of the UL ADU, packet, or the combination thereof is dropped.

12. The apparatus UE of claim 1, wherein the at least one processor is configured to cause the UE to determine a set of UL extended reality (XR) poses to be canceled based on a delay budget for a DL ADU, packet, or a combination thereof, an UL ADU, packet, or a combination thereof, or a combination thereof being exceeded.

13. The apparatus UE of claim 12, wherein the at least one processor is configured to cause the apparatus UE to indicate the set of UL XR poses to a network device.

14. The apparatus UE of claim 1, wherein the at least one processor is configured to cause the UE to receive an indication that the delay budget for a DL ADU, packet, or a combination thereof is exceeded or to be exceeded within a certain time, wherein, in response to the indication, the at least one processor is configured to cause the UE to determine a set of UL extended reality (XR) poses to be canceled, muted, or a combination thereof.

15. A method performed by a user equipment (UE), the method comprising:
transmit a first configured grant (CG) uplink (UL) transmission, wherein the first CG UL transmission initiates a channel occupancy time (COT), wherein;
the first CG UL transmission includes a CG uplink control information (UCI) (CG-UCI), and wherein the first CG-UCI indicates a first offset, a first duration, or a combination thereof;
determining a first starting time for downlink (DL) transmission based on the first offset, the first duration, or the combination thereof and a time that the first CG-UCI is transmitted;
determining whether a delay budget for an UL application data unit (ADU), packet, or a combination thereof is less than a threshold value; and
determining a second starting time for DL transmission, a second duration or a combination thereof based on:
whether the delay budget is less than the threshold value;
the first offset, the first duration, an un-transmitted portion of the UL ADU, packet, or the combination thereof;
or a combination thereof, wherein:
the second starting time is different than the first starting time, the second duration is different than the first duration, or a combination thereof;
the UE does not expect to receive DL transmission in the COT prior to the second starting time; and
the UE does not expect to receive DL transmission in the COT for a duration larger than the second duration.

16. A processor for wireless communication, comprising:
at least one controller coupled with at least one memory and configured to cause the processor to:
transmit a first configured grant (CG) uplink (UL) transmission, wherein the first CG UL transmission initiates a channel occupancy time (COT), wherein the first CG UL transmission includes a first CG uplink control information (UCI) (CG-UCI), and wherein the first CG-UCI indicates a first offset, a first duration, or a combination thereof;
determine a first starting time for downlink (DL) transmission based on the first offset, the first duration, or the combination thereof and a time that the first CG-UCI is transmitted;
determine whether a delay budget for an UL application data unit (ADU), packet, or a combination thereof is less than a threshold value; and
determine a second starting time for DL transmission, a second duration or a combination thereof based on:
whether the delay budget is less than the threshold value;
the first offset, the first duration, an un-transmitted portion of the UL ADU, packet, or the combination thereof,
or a combination thereof, wherein:
the second starting time is different than the first starting time, the second duration is different than the first duration, or a combination thereof,
the processor does not expect to receive DL transmission in the COT prior to the second starting time; and
the processor does not expect to receive DL transmission in the COT for a duration larger than the second duration.

17. The processor of claim 16, wherein a second CG-UCI is included in a second CG UL transmission, and the second CG-UCI indicates a second offset, the second duration, or a combination thereof.

18. The processor of claim 17, wherein the second CG UL transmission occurs at least a certain time after the first CG UL transmission.

19. The processor of claim 16, wherein the second starting time occurs at least a certain time earlier than the first starting time.

20. The processor of claim 16, wherein the second duration is greater than the first duration.
